(19) United States
(12) Patent Application Publication
(10) Pub. No.: US 2018/0046146 A1
(43) Pub. Date: Feb. 15, 2018

(54) METHOD AND EMBEDDED SYSTEM FOR MONITORING, CONTROLLING, OR REGULATING A MACHINE

(71) Applicant: Kriwan Industrie-Elektronik GmbH, Forchtenberg (DE)

(72) Inventor: Christian Ellwein, Schwäbisch Hall (DE)

(21) Appl. No.: 15/645,220

(22) Filed: Jul. 10, 2017

(30) Foreign Application Priority Data
Aug. 10, 2016 (DE) 102016114805.9

(51) Int. Cl. G05B 9/02

(52) U.S. Cl. CPC G05B 9/02

(57) ABSTRACT

A method for monitoring, controlling, or regulating a machine by means of an embedded system includes a first processor acted on by an input signal that is processed using a first algorithm implemented in the first processor in order to generate a first output signal for controlling or regulating the machine. The first algorithm of the first processor is modifiable via a network interface. In the embedded system, a second processor that is not connected to the network interface is used and is acted on by the same input signal, which is processed using a second algorithm that is implemented in the second processor in order to generate a second output signal. The first output signal and the second output signal are compared to one another to determine whether the first algorithm has been modified with respect to the second algorithm.

### FIELD OF THE INVENTION

The invention relates to a method for monitoring, controlling, or regulating a machine by means of an embedded system having a first processor which is acted on by an input signal that is processed using a first algorithm that is implemented in the first processor in order to generate a first output signal for controlling or regulating the machine, the first algorithm of the first processor being modifiable via a network interface.

### BACKGROUND OF THE INVENTION

For networked components in the industrial environment, there is a risk of hacker attacks and undesirable manipulations. Nowadays, software installations such as firewalls or a high degree of encryption no longer provide sufficient security in many cases. In current IT standards and operating systems, vulnerabilities that allow unauthorized access are continually becoming known.

For an embedded system such as a controller or protective relay, there is also a great risk that its parameters may be modified undetected, so that it no longer carries out the desired function. Thus, for example P, I, and D parameters for a controller or the cut-off current for a protective relay may be modified. Such errors are difficult to detect, since the device appears to still be functioning. The attack by the Stuxnet malware in Iran in particular exploited security gaps in the operating system, and made serious interventions in the control system.

### SUMMARY OF THE INVENTION

The object of the invention, therefore, is to improve the protection from unauthorized manipulations in an embedded system.

This object is achieved according to the invention by the features of claims 1 and 6.

In the method according to the invention for monitoring, controlling, or regulating a machine by means of an embedded system, a first processor is provided which is acted on by an input signal that is processed using a first algorithm that is implemented in the first processor in order to generate a first output signal for controlling or regulating the machine, the first algorithm being modifiable via a network interface. According to the invention, a second processor that is not connected to the network interface is used which is acted on by the same input signal, which is processed using an algorithm that is implemented in the second processor in order to generate a second output signal. The first output signal of the first processor and the second output signal of the second processor are then compared to one another to determine whether the first algorithm has been modified with respect to the second algorithm.

The system according to the invention for monitoring, controlling, or regulating a machine has at least one system input and at least one system output, and a first processor having a first processor input that is connected to the system input, and a first processor output that is connected to the system output, the first processor also being connected to at least one network interface. In addition, a second processor is provided which has at least one second processor input and at least one second processor output, the first processor input and the second processor input being connected to the system input for receiving the same input signal, and in addition a comparator being provided which is connected to the first processor output and the second processor output in order to compare output signals that are generated in the first and the second processor.

The invention further relates to a machine having at least one sensor for detecting a parameter of the machine, the sensor being connected to the system input of the embedded system according to one of claims 5 through 9.

Within the meaning of the invention, an embedded system is understood to mean a system having at least one processor that is integrated in a technical context. The processor in particular hereby takes on monitoring, control, or regulation functions, and in particular may also process data or signals.

Considered as machines within the meaning of the invention are in particular those machines having at least one electric motor, wherein parameters of the machine, in particular the electric motor, such as current, voltage, or power values, are transmitted via the system input. Furthermore, temperature values of the machine, in particular the electric motor, such as the winding temperature, may be detected via suitable sensors and supplied as an input signal to the embedded system. The machine is preferably formed by a pump, a compressor, a fan, or a hoist.

The method according to the invention and the embedded system according to the invention take into account the requirements of industry for an uncomplicated, rapid adaptation of the system via a network interface. However, even when appropriate security precautions are taken, it cannot be entirely ruled out that persons may improperly gain access and carry out manipulations. Due to providing the second processor, however, a processor which is independent of the network interface is present, and which in the normal case operates with the same algorithm as the first processor. However, if the first algorithm in the first processor is now manipulated in an unauthorized manner, the comparator determines different output signals of the two processors, and may then generate an appropriate alarm signal and/or take measures for switching off the machine.

In addition, it may be provided that in the case of an authorized modification of the first algorithm, it may be transmitted to the second processor. For example, a connecting line between the two processors may be enabled in order to transmit the first algorithm to the second processor. For this purpose, a switch that is physically activatable or activatable via a wireless communication channel that is independent of the network interface may be situated in the enableable connecting line. The wireless communication channel may be in the form of a mobile wireless connection, for example.

### BRIEF DESCRIPTION OF THE DRAWINGS

Further embodiments of the invention are explained in greater detail based on the following description of one exemplary embodiment.

FIG. 1 shows a block diagram of an embedded system.

### DETAILED DESCRIPTION OF ILLUSTRATIVE EMBODIMENTS

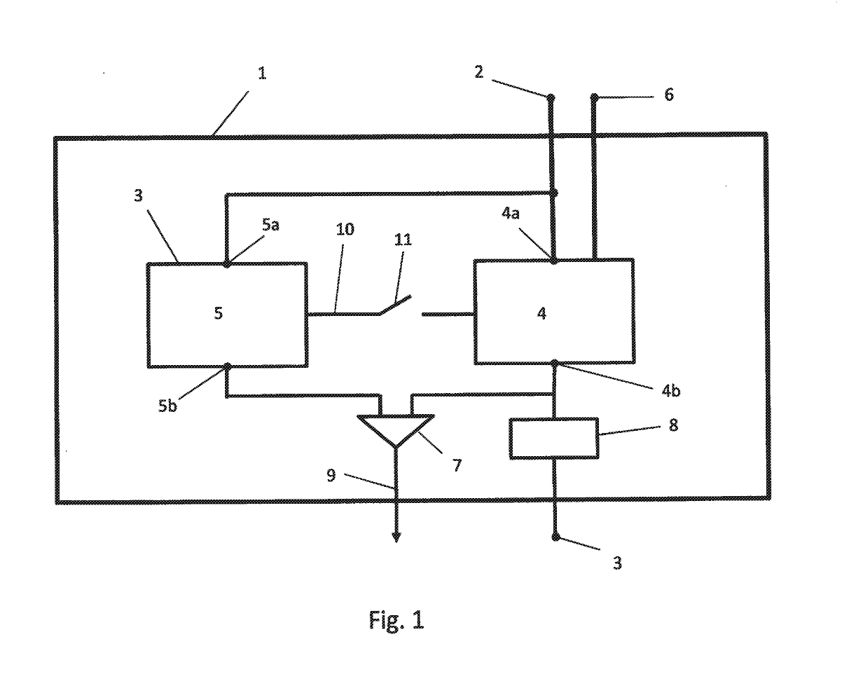

The embedded system 1 illustrated in FIG. 1 represents, for example, a protective relay or a controller or the like for monitoring, controlling, or regulating a machine. The machine is in particular a machine having an electric motor. The machine may be a refrigeration system, a hoist, a fan, or a pump system, for example.

The embedded system 1 has at least one system input 2 and at least one system output 3, as well as a first processor 4 and a second processor 5. The first processor 4 has a first processor input 4a that is connected to the system input 2, and a first processor output 4b that is connected to the system output 3. The first processor 4 is also connected to a network interface 6.

The second processor has a second processor input 5a that is likewise connected to the system input 2, so that both processors 4, 5 are acted on by the same input signal. The input signal is emitted, for example, from a sensor situated in the machine/electric motor.

Also provided in the embedded system 1 is a comparator 7 which is connected to the first processor output 4b of the first processor 4 and to a second processor output 5b of the second processor 5, and which is thus acted on by the two output signals of the two processors 4, 5.

In addition, a control or regulation unit 8, a relay, for example, is provided between the first processor output 4b and the system output 3 in order to control, regulate, or switch off the machine connected to the embedded system 1.

The two output signals of the two processors 4, 5 are compared to one another in the comparator 7. If no difference is determined, it is assumed that both processors 4, 5 are operating with the same algorithm. However, if the first algorithm of the first processor 4 has been modified in an authorized or unauthorized manner via the network interface 6 or in some other way, different output signals result at the processor outputs 4b, 5b, which is determined in the comparator 7 and causes an alarm signal 9 to be generated, which is suitably relayed. Alternatively, automated measures may be taken for switching off the machine. For this purpose, the alarm signal 9 may, for example, switch off the motor contactor for the machine, or the alarm signal 9 is read into a higher-level control center or control system and acoustically or optically displayed at that location.

If an authorized modification of the first algorithm in the first processor 4 has taken place, it is necessary to also implement the modified first algorithm in the second processor 5, so that in the future the comparator is able to determine a new modification of the first algorithm. For this purpose, the first processor 4 and the second processor 5 are connected to one another via an enableable connecting line 10. For this purpose, a switch 11 that is physically activatable or activatable via a wireless communication channel that is independent of the network interface 6 may be situated in the connecting line.

Thus, the switch 11 is not activatable via the network interface, and in the ideal case is a switch that is physically activatable on site. In this way, a transfer of the first algorithm from the first processor 4 to the second processor 5 takes place only when the transfer is initiated in a targeted manner, which occurs only when the first algorithm has been modified in an authorized manner.

However, if the comparator 7 determines different output signals of the two processors 4, 5 without an authorized modification of the first algorithm in the first processor haven taken place, it is assumed that an unauthorized modification of the first algorithm is present. In this case, the alarm signal 9 is generated in order to then take individual measures. It may also be checked in particular for whether other systems are also affected.

By providing two processors and the comparator in the embedded system, unauthorized modifications of the first algorithm of the first processor 4 may recognized immediately in order to take suitable measures in a timely manner.

1. A method for monitoring, controlling, or regulating a machine by means of an embedded system having a first processor which is acted on by an input signal that is processed using a first algorithm that is implemented in the first processor in order to generate a first output signal for controlling or regulating the machine, the first algorithm of the first processor being modifiable via a network interface,
characterized in that in the embedded system, a second processor that is not connected to the network interface is used which is acted on by the same input signal, which is processed using a second algorithm that is implemented in the second processor in order to generate a second output signal, the first output signal of the first processor and the second output signal of the second processor being compared to one another to determine whether the first algorithm has been modified with respect to the second algorithm.

2. The method according to claim 1, characterized in that the first output signal of the first processor and the second output signal of the second processor are compared to one another by means of a comparator, and in the event of an unauthorized modification of the first algorithm, the comparator determines different output signals of the two processors, and then generates an alarm signal and/or takes measures for switching off the machine.

3. The method according to claim 1, characterized in that in the event of an unauthorized modification of the first algorithm, an alarm signal is generated and/or measures for switching off the machine are taken.

4. The method according to claim 1, characterized in that in the event of an authorized modification of the first algorithm, the first algorithm is transferred from the first processor to the second processor.

5. The method according to claim 4, characterized in that a connecting line between the two processors is enabled in order to transfer the first algorithm from the first processor to the second processor.

6. An embedded system for monitoring, controlling, or regulating a machine, having at least one system input and at least one system output, and a first processor having a first processor input that is connected to the system input, and a first processor output that is connected to the system output, the first processor also being connected to at least one network interface,
characterized in that a second processor is provided which has at least one second processor input and at least one second processor output, the first processor input and the second processor input being connected to the system input for receiving the same input signal, and in addition a comparator being provided which is connected to the first processor output and the second processor output in order to compare output signals that are generated in the first and the second processor.

7. The embedded system according to claim 6, characterized in that a control or regulation unit is provided which is connected to the first processor output, and is connected to the system output.

8. The embedded system according to claim 6, characterized in that the first processor has an implemented first algorithm for processing the input signal, and the second processor has an implemented second algorithm for processing the input signal.

9. The embedded system according to claim 6, characterized in that an enableable connecting line for transferring the algorithm, implemented in one of the two processors, to the other processor is situated between the first and the second processor.

10. The embedded system according to claim 9, characterized in that a switch that is physically activatable or activatable via a wireless communication channel that is independent of the network interface is situated in the enableable connecting line.

11. A machine having at least one sensor for detecting a parameter of the machine, the sensor being connected to the system input of the embedded system according to claim 6.

12. The machine according to claim 11, characterized in that the machine is formed by a pump, a compressor, a fan, or a hoist.
